(19) United States
(12) Patent Application Publication
(10) Pub. No.: US 2025/0245340 A1
(43) Pub. Date: Jul. 31, 2025

(54) SYSTEMS AND METHODS FOR MITIGATING THIRD-PARTY CODE VULNERABILITIES IN AI-ASSISTED CODE GENERATION

(71) Applicant: Microsoft Technology Licensing, LLC, Redmond, WA (US)

(72) Inventors: Kevin John ALWELL, Colts Neck, NJ (US); Thomas Patrick HORTON, Auburn, NY (US)

(21) Appl. No.: 18/423,055

(22) Filed: Jan. 25, 2024

(51) Int. Cl. G06F 21/57

(52) U.S. Cl. CPC G06F 21/577; G06F 2221/033

(57) ABSTRACT

Systems and methods are provided for mitigating third-party code vulnerabilities in AI code generation services. A large language model generates an inference based on a user's code generation request. A middleware layer intercepts the inference prior to its availability within an AI pair programming client and parses the inference to identify third-party packages. A validation module checks the identified third-party packages against one or more registries of certified packages. If an uncertified third-party package is detected, the middleware layer either redacts the inference or modifies it by identifying a certified third-party package alternative. The system enhances security in AI-assisted code generation by ensuring the use of certified third-party packages.

### BACKGROUND

Artificial Intelligence (AI) has become an integral part of modern software development. AI-assisted code generation services, such as GitHub Copilot, for example, utilize large language models (LLMs) like Generative Pretrained Transformers (GPTs) to generate code based on a user's request. These services can accelerate code development processes by suggesting previously generated snippets and functions, or even complete modules to solve a given problem.

One common practice in software development is the use of third-party packages or libraries. These packages, often open-source, provide pre-built functionalities that developers can incorporate into their applications, thereby reducing the time and effort spent on coding from scratch. However, the use of third-party packages introduces potential security risks. These packages may contain vulnerabilities that can be exploited, leading to security breaches in the applications that use them.

Large language models used in AI-assisted code generation services are trained on vast amounts of data, including code snippets that incorporate third-party packages. When generating code in response to a user's request, these models may suggest the use of third-party packages based on the patterns they have learned from the training data. However, the training data is static and does not reflect the real-time updates and patches applied to these third-party packages after the model was trained. As a result, the model may suggest the use of outdated or vulnerable versions of third-party packages.

Furthermore, in an enterprise setting, organizations often maintain a list of certified or approved third-party packages to ensure the security and integrity of their software. These approved packages are typically stored in a private registry and have been vetted for security vulnerabilities. However, AI-assisted code generation services may not be aware of these organization-specific restrictions and may suggest the use of unapproved or uncertified packages.

In view of the foregoing, there is a desire to improve the manner in which AI-assisted code generation services can be performed while mitigating third-party code vulnerabilities during AI-assisted code generation.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Disclosed embodiments include systems and methods for mitigating third-party code vulnerabilities in AI code generation services.

In some embodiments, systems are provided for mitigating third-party code vulnerabilities in AI code generation services, wherein the system includes or utilizes: a large language model configured to generate an inference based on a user's code generation request; a middleware layer configured to intercept the inference prior to its availability within an AI client user interface, parse the inference to identify third-party packages included in the inference; and a validation module utilized by the middleware layer to determine whether the identified third-party packages included in the inference are certified by at least checking the identified third-party packages against one or more registries of certified packages, the middleware layer being further configured, upon determining that the inference includes an uncertified third-party package that is not included in the one or more registries of certified packages, to either (i) redact the inference or uncertified third-party package or (ii) modify the inference by at least including an identification of a certified third-party package that is an alternative to the uncertified third-party package.

In some aspects, the techniques described herein relate to a method for mitigating third-party code vulnerabilities in AI code generation services, the method including: receiving a code generation request from a user; generating an inference based on the code generation request using a large language model; intercepting the inference prior to its availability within an AI client user interface; parsing the inference to identify third-party packages included in the inference; checking the identified third-party packages against one or more registries of certified packages; and upon determining that the inference includes an uncertified third-party package that is not included in the one or more registries of certified packages, at least one of (i) redacting the inference or uncertified third-party package or (ii) modifying the inference by at least including an identification of a certified third-party package that is an alternative to the uncertified third-party package.

In some aspects, the techniques described herein relate to a hardware storage device including stored computer-executable instructions that are executable by one or more hardware processors of a system for mitigating third-party code vulnerabilities in AI code generation for causing the system to: receive a code generation request from a user; generate an inference based on the code generation request using a large language model; intercept the inference prior to its availability within an AI client user interface; parse the inference to identify third-party packages included in the inference; check the identified third-party packages against one or more registries of certified packages; and upon determining that the inference includes an uncertified third-party package that is not included in the one or more registries of certified packages, at least one of (i) redact the inference or uncertified third-party package or (ii) modify the inference by at least including an identification of a certified third-party package that is an alternative to the uncertified third-party package.

This Summary is provided to introduce a selection of concepts that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not, therefore, to be limiting in scope, embodiments will be described and explained with additional specificity and detail through the use of the accompanying drawings in which:

FIG. 1 illustrates an example embodiment in which a middleware layer of a system interfaces with one or more third-party package registries and includes or interfaces with a Large Language Model (LLM) to process an LLM prompt received from a client user interface to process inferences generated by the LLM in response to the prompt and in which the inference is modified to replace or redact uncertified packages from the inference and processed into an LLM response for the AI client user interface in response to the LLM prompt.

FIG. 2 illustrates a process flow diagram that illustrates additional details for processing the inference from the LLM into a modified inference and corresponding LLM response.

FIG. 3 illustrates an example embodiment, similar to the example embodiment of FIG. 1, in which a middleware layer of a system interfaces with one or more third-party package registries and includes or interfaces with a Large Language Model (LLM) to process an initial LLM prompt received from a client user interface to process an initial inference generated by the LLM in response to the initial prompt and in which validation processes performed on the initial inference cause the middleware layer to generate one or more new prompt(s) for the LLM to obtain one or more new inference(s) that omits at least one uncertified package included in the initial inference, wherein the new inference(s) can be used to generate an LLM response to the initial LLM prompt.

FIG. 4 illustrates a process flow diagram that includes acts associated with performing aspects of the disclosed embodiments.

FIG. 5 illustrates an example computing environment in which a computing system incorporates and/or is utilized to perform aspects of the disclosed embodiments.

### DETAILED DESCRIPTION

Disclosed embodiments include systems, methods and devices that may be used for mitigating third-party code vulnerabilities during AI-assisted code generation.

As discussed herein, the disclosed embodiments beneficially process AI-generated inferences, which are generated in response to code generation prompts, to modify the inferences to omit uncertified packages and code vulnerabilities prior to the inferences being processed into responses to the prompts. In this manner, it is possible to help reduce the propagation of code vulnerabilities during code development with AI-assisted code generation tools. Accordingly, the disclosed systems beneficially enhance the security and reliability of code generated by AI services by ensuring that the third-party packages included in the generated code are certified and free from known vulnerabilities. This is particularly relevant in the context of AI pair programming services, such as GitHub Copilot, which rely on large language models to generate code based on a user's request.

In a typical scenario, a user submits a code generation request to the AI service. The AI service, utilizing a large language model, generates an inference or a proposed solution based on the user's request. This inference often includes the use of third-party packages, which are software components developed by third parties and commonly used in software development to accelerate the development process and avoid reinventing the wheel. However, the use of third-party packages introduces the risk of incorporating code that contains known vulnerabilities, which can compromise the security of the application being developed.

To address this issue, the disclosed systems include a middleware layer that intercepts the inference generated by the large language model before it is made available within the AI client user interface. The middleware layer parses the inference to identify the third-party packages included in the inference. This parsing process may involve identifying the programming language of the code in the inference and applying language-specific rules to identify the third-party packages.

Once the third-party packages have been identified, the system utilizes a validation module to determine whether the identified third-party packages are certified. This involves checking the identified third-party packages against one or more registries of certified packages. The registries may include third-party registries such as Artifactory or other third-party registries. These registries may be updated in real-time to reflect the latest security patches and updates, and may be private registries maintained by a user's organization. The registries may also comprise or utilize approved dependency hash tables or indexes of approved packages.

If the validation module determines that the inference includes an uncertified third-party package that is not included in the one or more registries of certified packages, the middleware layer takes action to mitigate the risk. Specifically, the middleware layer may either redact the inference or uncertified third-party package, or modify the inference by including an identification of a certified third-party package that is an alternative to the uncertified third-party package. In this way, the system ensures that the code generated by the AI service is secure and reliable, and that it complies with the user's or organization's policies regarding the use of third-party packages.

In some instances, the system employs (e.g., incorporates or utilizes) a large language model (LLM) to generate an inference based on a user's code generation request. The LLM is a type of artificial intelligence model that is trained on a vast amount of text data. It uses this training to generate human-like text that is contextually relevant to the input it receives. In the context of code generation, the LLM receives a code generation request from a user and generates an inference, which is a proposed solution to the user's request. This inference often includes the use of third-party packages, which are software components developed by third parties.

In some cases, the LLM used in the system may be a Generative Pretrained Transformer (GPT). GPT is a type of LLM that uses a transformer architecture, which allows it to handle long-range dependencies in the input data and generate high-quality text. GPT is pretrained on a large corpus of text data and can generate text that is contextually relevant to the input it receives. In the context of code generation, a GPT-based LLM can generate code that is syntactically correct and contextually relevant to the user's request.

By using a GPT-based LLM, the system can generate high-quality inferences that are contextually relevant to the user's code generation request. However, the use of third-party packages in these inferences introduces the risk of incorporating code that contains known vulnerabilities. To mitigate this risk, the system includes a middleware layer that intercepts the inference generated by the LLM and checks the third-party packages included in the inference against one or more registries of certified packages, as discussed.

In some instances, the middleware layer intercepts and processes the inference generated by the large language model before it is made available within the AI client user interface. This interception allows the middleware layer to parse and process the inference to identify any third-party packages included in the inference. The parsing process may involve identifying the programming language of the code in the inference, identifying names, elements, schemas and other features of the code and applying language-specific rules to identify the third-party packages. The middleware layer may also generate prompts, in some instances, to an index or LLM to query for more information or identification of the third-party packages included in the inferences.

The parsing and processing of the inference may also include generating hashes of the identified third-party packages to compare against the hashes in registry tables of approved or certified third-party packages. This ensures that the system has a comprehensive understanding of the components of the inference and can accurately identify any third-party packages that may be included.

In some cases, if the inference fails to include any certified third-party package, the middleware layer may modify the inference into a new/modified inference with alternative third-party packages that are certified and that are identified by the system as being suitable substitutes to uncertified third-party packages included in the inference and that perform similar functionality. The middleware layer may use rules and/or trained logic to identify packages having similar functionality. Additionally, or alternatively, the middleware layer may interface with a remote module to query for suitable alternates to any identified uncertified third-party packages.

In some instances, the system may also interface with the LLM to cause the LLM to generate a new replacement inference by sending a new set of one or more prompts to the LLM to cause the LLM to generate the new/replacement inference that omits at least one uncertified third-party package that was included in the initial inference. The generation of a new inference by the LLM may include processes of generating and providing an exclusion list to the large language model of uncertified packages to exclude from future inferences.

In preferred embodiments, any new or modified inference created by the foregoing processes will exclude any uncertified packages that were included in the initial inference. If a new or modified inference does still contain an uncertified package, the system may iterate the previous processes to obtain yet another new and/or modified inference that excludes any uncertified packages.

Additionally, the middleware layer may also provide a warning to the user when an uncertified third-party package is identified in the inference. This warning informs the user of the potential security risk associated with the uncertified package. In addition to providing a warning, the middleware layer may also modify the inference to provide a suggestion to the user for a certified third-party package that can replace the uncertified third-party package identified in the inference. This provides the user with a secure alternative to the uncertified package if the uncertified package is ultimately identified in the LLM response provided to the user at the AI client user interface.

In some cases, the middleware layer may use a caching mechanism to store the latest version of the registry of certified packages. This reduces the number of queries to the registry service, enhancing the efficiency of the system. The middleware layer may store such registry information in a hashmap or other data structure for efficient lookup of the certified packages. This allows the middleware layer to quickly determine whether a package is certified, further enhancing the efficiency and effectiveness of the system.

In view of the foregoing, it will be appreciated that the system includes or utilizes a validation module that can be used to promote, and sometimes ensure, the security and reliability of the code that is generated using an AI-code generation service. Notably, the validation module is utilized by the middleware layer to determine whether the identified third-party packages included in the inference are certified. This determination is made by checking the identified third-party packages against one or more registries of certified packages that have been certified as being secure and free from known vulnerabilities.

In some cases, these registries of certified packages are updated in real-time to reflect the latest security patches and updates. This ensures that the system is aware of the latest security information and can accurately determine whether a third-party package is certified. This real-time updating of the registries enhances the system's ability to mitigate the risk of incorporating code with known vulnerabilities into the generated code.

In some configurations, the one or more registries of certified packages are private registries maintained by a user's organization. This allows the system to be tailored to the specific security policies and requirements of the user's organization. By checking the identified third-party packages against these private registries, the system ensures that the generated code complies with the organization's policies regarding the use of third-party packages.

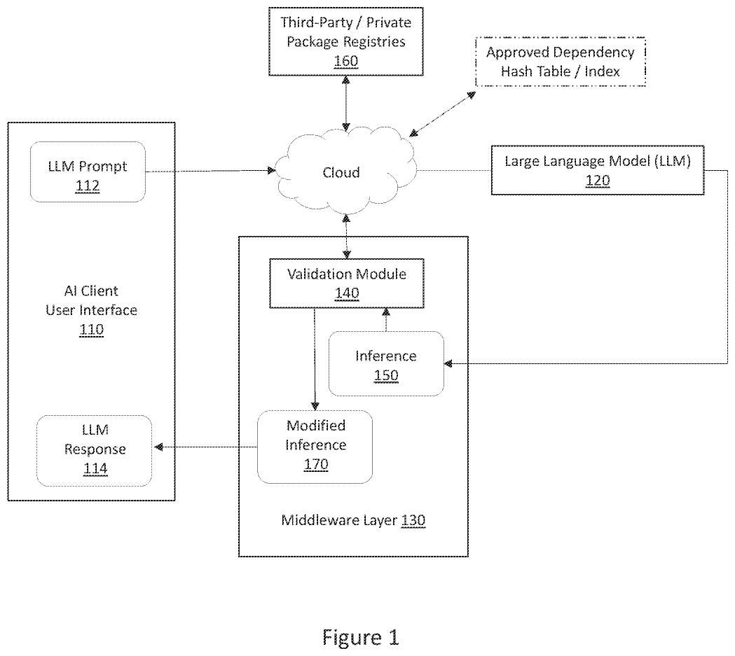

Attention will now be directed to FIG. 1, which illustrates an example embodiment in which a middleware layer 130 of a system interfaces with one or more third-party package registries 160 and includes or interfaces with a Large Language Model (LLM) 120 to process an LLM prompt 112 received from an AI client user interface 110. The middleware layer 130 uses a validation module 140 to process the inference 150 generated by the LLM 120 in response to the LLM prompt 112 and in which the inference 150 is modified to replace or redact uncertified packages from the inference 150 and to further process the inference 150 (as a new or a modified inference 170) into an LLM response 114 for the AI client user interface 110 in response to the LLM prompt 112.

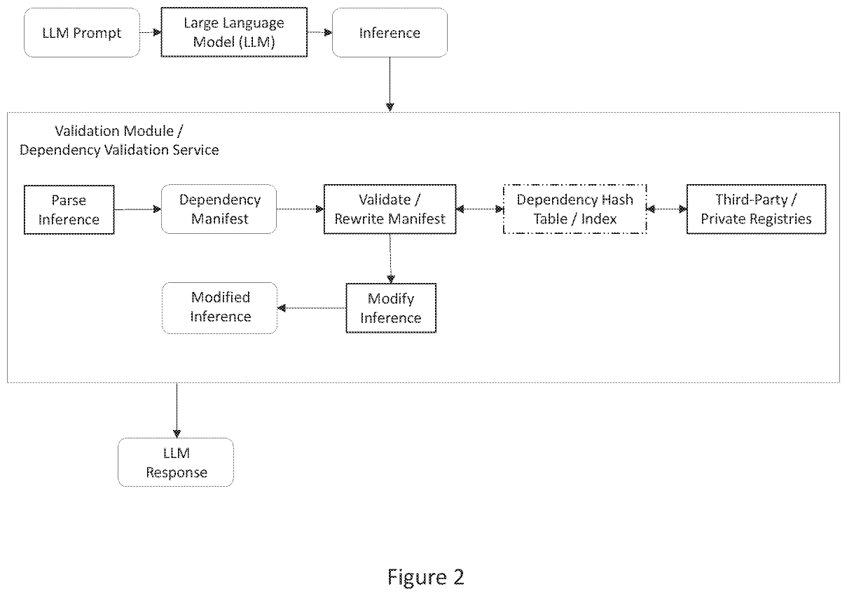

FIG. 2 illustrates a process flow diagram that illustrates additional details for processing the inference from the LLM into a modified inference and corresponding LLM response.

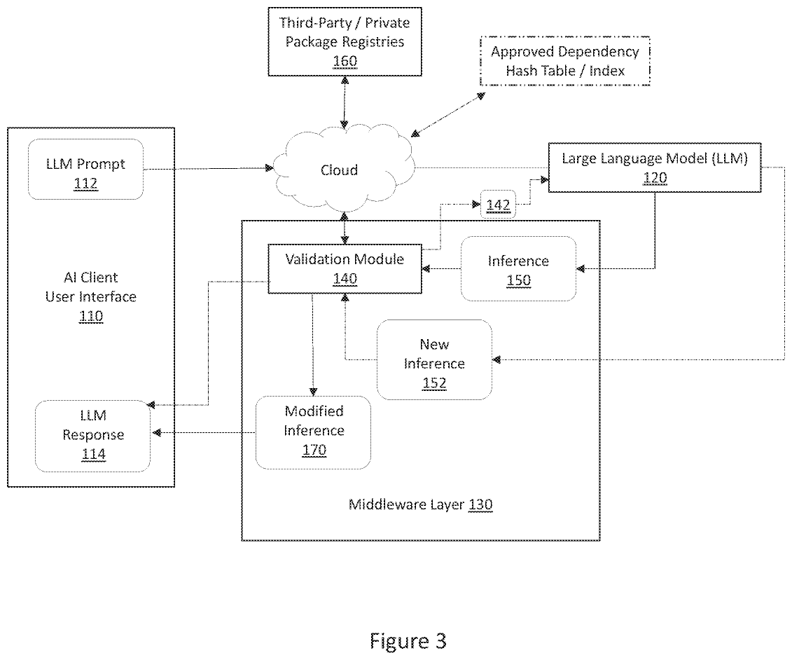

FIG. 3 illustrates an example embodiment, similar to the example embodiment of FIG. 1, in which a middleware layer of a system interfaces with one or more third-party package registries and includes or interfaces with a Large Language Model (LLM) to process an initial LLM prompt received from a client user interface to process an initial inference generated by the LLM in response to the initial prompt and in which validation processes performed by a validation module 140 on the initial inference cause the middleware layer to generate one or more new prompt(s) for the LLM to obtain one or more new inference(s) that omits at least one uncertified package included in the initial inference, wherein the new inference(s) can be used to generate an LLM response to the initial LLM prompt.

FIG. 2 illustrates a process flow diagram that includes additional details regarding the processing of an inference into a modified inference and a corresponding LLM response to an initial LLM prompt. For instance, as shown, the LLM prompt is processed by the LLM into an inference that is processed by a validation module of the disclosed systems. This validation module may be locally stored and/or distributed among disparate, but connected, systems. The validation module may, for example, be instantiated as a dependency validation service that is called by a system that is interposed between a client system and an LLM system.

In some instances, as described, the inference may include one or more uncertified package. During processing of the inference by the validation module, the uncertified package is identified and removed and, optionally, replaced. The processing of the inference includes the validation module parsing the inference to generate a dependency manifest that identifies the different packages identified in the inference. The validation module then validates these packages by comparing hashes of the packages with hashes contained in a dependency hash table or index of approved and certified packages, such as can be maintained by a remote third-party registry and/or a local enterprise registry.

Importantly, the inference is intercepted prior to being provided to a client within an LLM response corresponding to the initial code generation LLM prompt. This enables the validation module to remove any uncertified packages identified in the dependency manifest and, optionally, to replace any such uncertified packages with certified alternate packages that perform similar functionality. Sometimes, an alternate package may simply be a patch or more recent version of a previously indexed package that is no longer certified in view of new updates to a legacy or older version of the package, for example.

Importantly, the validation module intercepts the inference prior to the LLM response being generated and/or provided to the client based on the inference to the initial LLM prompt.

FIG. 3, like FIG. 1 also illustrates system that includes a middleware layer 130 that interfaces with one or more third-party or private package registries 160 and includes or interfaces with a Large Language Model (LLM) 120 to process an initial LLM prompt 112 received from a client user interface 110 to process an initial inference 150 generated by the LLM in response to the initial prompt and in which validation processes performed on the initial inference 150 cause the middleware layer 130 to generate one or more new prompt(s) 142 for the LLM 120 to obtain one or more new inference(s) 152 that omits at least one uncertified package included in the initial inference 150, wherein the new inference(s) 152 can be used to generate an LLM response 114 to the initial LLM prompt 112. The LLM response 114 can also be based at least partially on the modified inference 170 that is generated by the validation module in response to replacing and/or removing one or more uncertified package from the initial inference 150 and/or the new inference 152.

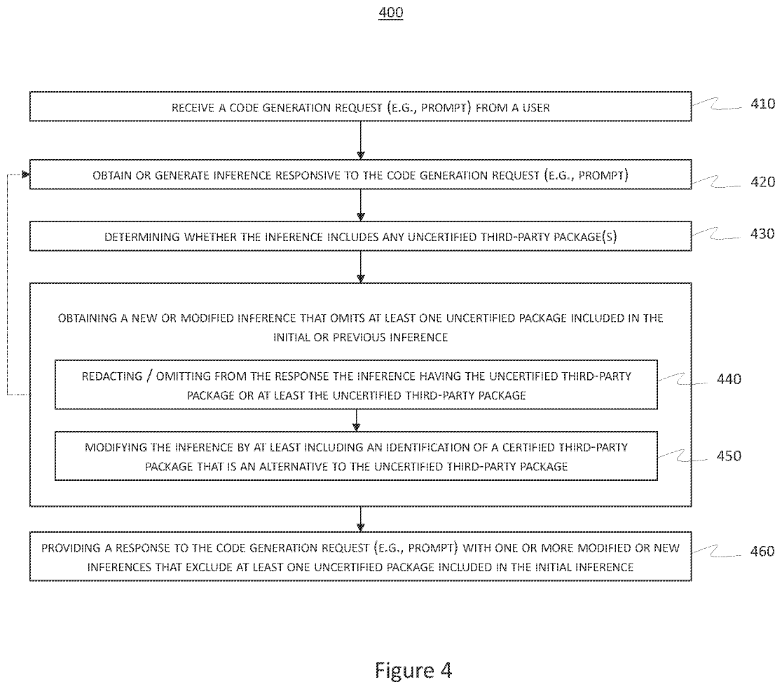

FIG. 4 illustrates a process flow diagram 400 that includes acts associated with performing aspects of the disclosed embodiments and that can be performed by the systems disclosed herein.

As shown, the flow diagram 400 includes an act of a system receiving a code generation request from a user (act 410). This request may comprise, for example, a prompt that is entered into an AI client interface such as a browser, a GPT interface, or a specialized code generation application. Next, the system obtains, causes an LLM to generate, or (when incorporating the LLM) generates an inference based on the code generation request using a large language model (act 420).

Next, the system determines whether the inference includes any uncertified third-party packages (act 430). This includes the system intercepting the inference prior to its availability within an AI client user interface and parsing the inference to identify third-party packages included in the inference with the processing that has previously been described.

The disclosed flow also includes, upon determining that the inference includes an uncertified third-party package that is not included in the one or more registries of certified packages, generating or obtaining a new or modified inference that omits at least one uncertified package that was included in the initial or a previously obtained inference (act 440). This may include, for example, corresponding acts of (i) redacting the inference or uncertified third-party package (act 450) or (ii) modifying the inference by at least including an identification of a certified third-party package that is an alternative to the uncertified third-party package (act 460).

The system may also iteratively perform any of these acts, such as shown by the dashed line 470, in which the system processes new and/or modified inferences to ensure that the new and modified inferences do not include any uncertified packages.

### Example Computing Systems

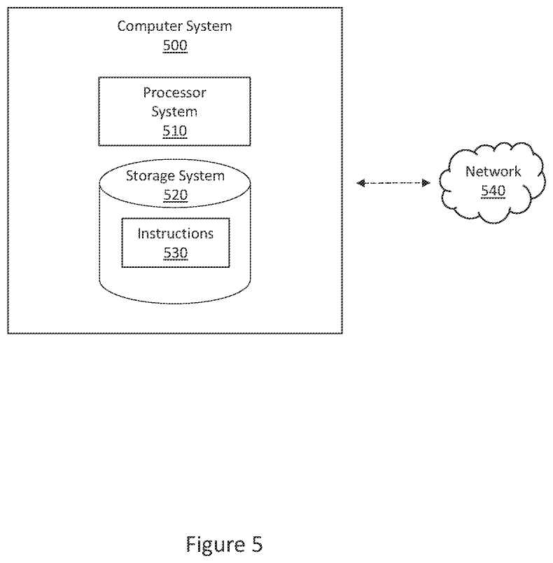

Attention will now be directed to FIG. 5, which illustrates an example computing environment in which a computing system incorporates and/or is utilized to perform aspects of the disclosed embodiments. As shown, the computing system 500 includes a processor system 510 containing one or more processor(s) (such as one or more hardware processor(s)) and one or more hardware storage device(s) comprising a storage system 520 storing computer-readable instructions 530. The storage system 520 is able to house any number of data types and any number of computer-executable instructions by which the computing system 500 is configured to implement one or more aspects of the disclosed embodiments when the computer-executable instructions are executed by the one or more hardware processor(s).

Although not shown, the computing system 500 also includes interface(s) and input/output (I/O) device(s) to facilitate communication of the different system components.

As shown, the storage system 520 is shown as a single storage unit. However, it will be appreciated that the hardware storage device(s) of the storage system 520 can also be a distributed storage that is distributed to several separate and sometimes remote systems and/or third-party system(s).

The computing system 500 can also comprise a distributed system with one or more of the components of computing system 500 being maintained/run by different discrete systems that are remote from each other and that are connected through a network 540, such as the Internet or any network that includes a combination of wired and wireless connections. In such a distributed environment, each system performs different tasks. In some instances, a plurality of distributed systems performs similar and/or shared tasks for implementing the disclosed functionality, such as in a distributed cloud environment.

Embodiments of the present invention may comprise or utilize a special-purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media (e.g., hardware storage device(s)) that store computer-executable/computer-readable instructions are physical hardware storage media/devices that exclude transmission media. Computer-readable media that carry computer-executable instructions or computer-readable instructions in one or more carrier waves or signals are transmission media. Thus, by way of example, and not limitation, embodiments of the invention can comprise at least two distinctly different kinds of computer-readable media: physical computer-readable storage media/devices and transmission computer-readable media.

Physical computer-readable storage media/devices are hardware and include RAM, ROM, EEPROM, CD-ROM or other optical disk storage (such as CDs, DVDs, etc.), magnetic disk storage or other magnetic storage devices, or any other hardware which can be used to store desired program code means in the form of computer-executable instructions or data structures and which can be accessed by a general purpose or special purpose computer.

A “network” (e.g., network 540) is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links that can be used to carry, or desired program code means in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAS, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

### Numbered Clauses

The present invention can also be described in accordance with the following numbered clauses.

Clause 1. A system for mitigating third-party code vulnerabilities in AI code generation services, the system comprising: a large language model configured to generate an inference based on a user's code generation request; a middleware layer configured to intercept the inference prior to its availability within an AI client user interface, parse the inference to identify third-party packages included in the inference; and a validation module utilized by the middleware layer to determine whether the identified third-party packages included in the inference are certified by at least checking the identified third-party packages against one or more registries of certified packages, the middleware layer being further configured, upon determining that the inference includes an uncertified third-party package that is not included in the one or more registries of certified packages, to either (i) redact the inference or uncertified third-party package or (ii) modify the inference by at least including an identification of a certified third-party package that is an alternative to the uncertified third-party package.

Clause 2. The system of clause 1, wherein the large language model is a Generative Pretrained Transformer.

Clause 3. The system of clause 1, wherein the middleware layer is further configured to generate a new inference if the inference fails to include any certified third-party package, wherein the new inference excludes any uncertified packages included in the inference.

Clause 4. The system of clause 1, wherein the parsing of the inference by the middleware layer includes identifying the programming language of the code in the inference and applying language-specific rules to identify the third-party packages.

Clause 5. The system of clause 1, wherein the one or more registries of certified packages are updated in real-time to reflect the latest security patches and updates.

Clause 6. The system of clause 1, wherein the one or more registries of certified packages are private registries maintained by a user's organization.

Clause 7. The system of clause 3, wherein generating a new inference includes providing an exclusion list to the large language model, the exclusion list comprising an identification of uncertified packages.

Clause 8. The system of clause 1, wherein the middleware layer is further configured to modify the inference by replacing an uncertified third-party package with an alternative certified third-party package that provides a similar functionality as the uncertified third-party package.

Clause 9. The system of clause 1, wherein the middleware layer is further configured to provide a warning to the user when an uncertified third-party package is identified in the inference.

Clause 10. The system of clause 1, wherein the middleware layer is configured to modify the inference to provide a suggestion to the user for a certified third-party package that can replace an uncertified third-party package identified in the inference.

Clause 11. A method for mitigating third-party code vulnerabilities in AI code generation services, the method comprising: receiving a code generation request from a user; generating an inference based on the code generation request using a large language model; intercepting the inference prior to its availability within an AI client user interface; parsing the inference to identify third-party packages included in the inference; checking the identified third-party packages against one or more registries of certified packages; and upon determining that the inference includes an uncertified third-party package that is not included in the one or more registries of certified packages, at least one of (i) redacting the inference or uncertified third-party package or (ii) modifying the inference by at least including an identification of a certified third-party package that is an alternative to the uncertified third-party package.

Clause 12. The method of clause 11, wherein the large language model is a Generative Pretrained Transformer.

Clause 13. The method of clause 11, further comprising generating a new inference if all identified third-party packages in the initial inference are determined to be uncertified for failing to be included in the one or more registries of certified packages, wherein the new inference excludes the uncertified third-party packages.

Clause 14. The method of clause 11, wherein the parsing of the inference includes identifying the programming language of the code in the inference and applying language-specific rules to identify the third-party packages.

Clause 15. The method of clause 11, wherein the registry of certified packages is updated in real-time to reflect the latest security patches and updates.

Clause 16. The method of clause 11, wherein the registry of certified packages is a private registry maintained by a user's organization.

Clause 17. A hardware storage device comprising stored computer-executable instructions that are executable by one or more hardware processors of a system for mitigating third-party code vulnerabilities in AI code generation for causing the system to: receive a code generation request from a user; generate an inference based on the code generation request using a large language model; intercept the inference prior to its availability within an AI client user interface; parse the inference to identify third-party packages included in the inference; check the identified third-party packages against one or more registries of certified packages; and upon determining that the inference includes an uncertified third-party package that is not included in the one or more registries of certified packages, at least one of (i) redact the inference or uncertified third-party package or (ii) modify the inference by at least including an identification of a certified third-party package that is an alternative to the uncertified third-party package.

Clause 18. The hardware storage device of clause 17, wherein the system is caused to redact the uncertified third-party package from the inference.

Clause 19. The hardware storage device of clause 17, wherein the system is caused to modify the inference by at least including an identification of a certified third-party package that is an alternative to the uncertified third-party package.

Clause 20. The hardware storage device of clause 19, further comprising presenting the modified inference to the AI client user interface.

What is claimed is:

1. A system for mitigating third-party code vulnerabilities in AI code generation services, the system comprising:
a large language model configured to generate an inference based on a user's code generation request;
a middleware layer configured to intercept the inference prior to its availability within an AI client user interface, parse the inference to identify third-party packages included in the inference; and
a validation module utilized by the middleware layer to determine whether the identified third-party packages included in the inference are certified by at least checking the identified third-party packages against one or more registries of certified packages,
the middleware layer being further configured, upon determining that the inference includes an uncertified third-party package that is not included in the one or more registries of certified packages, to either (i) redact the inference or uncertified third-party package or (ii) modify the inference by at least including an identification of a certified third-party package that is an alternative to the uncertified third-party package.

2. The system of claim 1, wherein the large language model is a Generative Pretrained Transformer.

3. The system of claim 1, wherein the middleware layer is further configured to generate a new inference if the inference fails to include any certified third-party package, wherein the new inference excludes any uncertified packages included in the inference.

4. The system of claim 1, wherein the parsing of the inference by the middleware layer includes identifying the programming language of the code in the inference and applying language-specific rules to identify the third-party packages.

5. The system of claim 1, wherein the one or more registries of certified packages are updated in real-time to reflect security patches and updates.

6. The system of claim 1, wherein the one or more registries of certified packages are private registries maintained by a user's organization.

7. The system of claim 3, wherein generating a new inference includes providing an exclusion list to the large language model, the exclusion list comprising an identification of uncertified packages.

8. The system of claim 1, wherein the middleware layer is further configured to modify the inference by replacing an uncertified third-party package with an alternative certified third-party package that provides a similar functionality as the uncertified third-party package.

9. The system of claim 1, wherein the middleware layer is further configured to provide a warning to the user when an uncertified third-party package is identified in the inference.

10. The system of claim 1, wherein the middleware layer is configured to modify the inference to provide a suggestion to the user for a certified third-party package that can replace an uncertified third-party package identified in the inference.

11. A method for mitigating third-party code vulnerabilities in AI code generation services, the method comprising:
receiving a code generation request from a user;
generating an inference based on the code generation request using a large language model;
intercepting the inference prior to its availability within an AI client user interface;
parsing the inference to identify third-party packages included in the inference;
checking the identified third-party packages against one or more registries of certified packages; and
upon determining that the inference includes an uncertified third-party package that is not included in the one or more registries of certified packages, at least one of (i) redacting the inference or uncertified third-party package or (ii) modifying the inference by at least including an identification of a certified third-party package that is an alternative to the uncertified third-party package.

12. The method of claim 11, wherein the large language model is a Generative Pretrained Transformer.

13. The method of claim 11, further comprising generating a new inference if all identified third-party packages in the inference are determined to be uncertified for failing to be included in the one or more registries of certified packages, wherein the new inference excludes the uncertified third-party packages.

14. The method of claim 11, wherein the parsing of the inference includes identifying a programming language of the code in the inference and applying language-specific rules to identify the third-party packages.

15. The method of claim 11, wherein the registry of certified packages is updated in real-time to reflect security patches and updates.

16. The method of claim 11, wherein the registry of certified packages is a private registry maintained by a user's organization.

17. A hardware storage device comprising stored computer-executable instructions that are executable by one or more hardware processors of a system for mitigating third-party code vulnerabilities in AI code generation for causing the system to:
receive a code generation request from a user;
generate an inference based on the code generation request using a large language model;
intercept the inference prior to its availability within an AI client user interface;
parse the inference to identify third-party packages included in the inference;
check the identified third-party packages against one or more registries of certified packages; and
upon determining that the inference includes an uncertified third-party package that is not included in the one or more registries of certified packages, at least one of (i) redact the inference or uncertified third-party package or (ii) modify the inference by at least including an identification of a certified third-party package that is an alternative to the uncertified third-party package.

18. The hardware storage device of claim 17, wherein the system is caused to redact the uncertified third-party package from the inference.

19. The hardware storage device of claim 17, wherein the system is caused to modify the inference by at least including an identification of a certified third-party package that is an alternative to the uncertified third-party package.

20. The hardware storage device of claim 19, further comprising presenting the modified inference to the AI client user interface.
